(19) United States
(12) Patent Application Publication
(10) Pub. No.: US 2008/0222909 A1
(43) Pub. Date: Sep. 18, 2008

(54) DRYING APPARATUS

(76) Inventors: Augusto Picozza, Boca Raton, FL (US); Kevin O'Doherty, Tseung Kwan O (HK); Chak Por Lee, Kowloon (HK)

Correspondence Address: Sunbeam Products, Inc., 2381 Executive Center Drive, Boca Raton, FL, 33431, US

(21) Appl. No.: 12/045,811

(22) Filed: Mar. 11, 2008

Related U.S. Application Data
(60) Provisional application No. 60/906,636, filed on Mar. 12, 2007.

(51) Int. Cl. F26B 9/06; F26B 19/00

(52) U.S. Cl. 34/195; 34/218

(57) ABSTRACT

The present disclosure is related to an apparatus suitable for cleaning, refreshing, steaming, deodorizing, and/or drying cloth items. Such appliance comprises a molded base form with an associated heater/blower assembly and a water receptacle, a rigid, telescoping framework hingedly affixed to the base form, and a collapsible enclosure defining a void space, and having at least one access port thereto and a plurality of removable shelves for inclusion therein.

### CROSS-REFERENCE TO RELATED APPLICATION

The present invention claims priority to U.S. Provisional Application No. 60/906,636 for Gentle Dryer, filed on Mar. 12, 2007, the content of which is herein incorporated by reference in its entirety.

### FIELD OF THE INVENTION

The present disclosure generally relates to an appliance useful for the cleaning and refreshing of fabrics. In particular, the present disclosure is directed to a portable appliance useful for the cleaning, drying, and refreshing of fabrics. More particularly, the present disclosure is directed to a collapsible, portable appliance, modular in its construction, so as to handle the cleaning, drying, and refreshing of fabrics in a hanging and/or laying orientation.

### BACKGROUND OF THE INVENTION

Certain fabrics are not suitable for conventional in-home immersion cleaning processes. Home washing machines can, under certain conditions, shrink or otherwise damage silk, linen, wool, and other delicate fabrics. Consumers typically have these delicate fabric items dry-cleaned. Other fabrics are easily wrinkled and ironing of these items is a time consuming and often undesirable task. Finally, some items are often worn only for special occasions and do not require an in-depth cleaning as might be required by clothing worn all-day or during strenuous physical activity. Such items often require nothing more than “freshening up” to be suitable for re-use.

With regard to those fabrics that are typically dry-cleaned, attempts have been made to provide in-home systems that combine the fabric cleaning and refreshing of in-home, immersion laundering processes with the fabric care benefits of dry-cleaning processes. One such in-home system for cleaning and refreshing garments comprises a substrate sheet containing various liquid or gelled cleaning agents, and a plastic enclosure. The garments are placed into the enclosure together with the sheet, and then tumbled in a conventional clothes dryer.

Unfortunately, such in-home processes are designed for use in a conventional clothes dryer. Such an appliance is not always available, and they are often uneconomical. Moreover, in many locales clothes dryers are unnecessary as local weather conditions provide an adequate environment to allow for year-round outdoor drying of clothing in the sun.

Steamer cabinets have also been utilized in the past to treat fabrics with heavy doses of steam, in an effort to both cleanse and deodorize the fabrics. Unfortunately, past steam cabinets were largely uncontrolled with respect to temperature and humidity. The cabinets were generally large appliances that were not portable. Due to the large uncontrolled amounts of steam used a drying step is often required that requires additional time and energy, as well as potentially resulting in undesirable shrinkage of the garment.

### SUMMARY OF THE INVENTION

In accordance with the present disclosure an apparatus suitable for refreshing/cleaning, steaming, deodorizing, and/or drying cloth fabrics is disclosed. Such apparatus may generally be comprised of a base and a foldable, telescoping rigid frame designed to support a suspended collapsible enclosure. Associated with the enclosure may be a portable heater, blower assembly with integral controls, including a plurality of temperature settings.

The base may be a molded plastic base having an internal configuration for directing any moisture collected from the drying clothing into a receptacle associated therein. Additionally, the base may include an integrally formed duct and vent for directing heated air or steam from the associated heater/blower assembly into the collapsible enclosure.

The enclosure may be comprised of any suitable sturdy material for forming the outermost housing of the apparatus. Such enclosure may be constructed to include internal points of attachment at various locations along its length to support removable shelves suited for supporting garments preferably dried in a horizontal position. Alternatively, such enclosure may further include an internal, collapsible ladder-like frame of suitable material for supporting removable shelves at those points along its length that correspond to the steps of the ladder structure. The shelves may be attached in any known suitable manner, but are preferably formed about a peripheral framework to ensure that the shelves remain in a semi-rigid and supportive configuration under load. Finally, the enclosure may include either a plurality of entry ports for access to clothing at various levels within the apparatus or alternatively, the apparatus may comprise a single access port having a configuration for opening such port from either end or along the entire length of the enclosure.

The enclosure is supported by a foldable, rigid, telescoping frame. Such frame may be comprised of a pair of inverted Y-shaped, telescoping members. Each of the pair of inverted Y-shaped members may be hinged at both of the corners of the side of the base with which it is associated. When opened, the frame may be extended to its full height by using snap lock, ball and detent, or other suitable securing means for maintaining the extended telescoping members. Finally, a single rod may be used to secure the uppermost ends of the pair of inverted Y-shaped members together. Such rod may also serve as the hanging rod for clothes being treated while on a hanger device.

Once fully erected, a user may choose to incorporate the removable shelves in a manner consistent with the structure used to support such shelves. Otherwise, clothing may be introduced into the apparatus through the at least one access port for treatment. The heater/blower may be set as appropriate to the treatment selected and the access port secured to allow the apparatus to either clean, refresh, steam, deodorize, or dry the cloth fabric therein.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a front isometric view of the portable garment treatment apparatus of the present disclosure;

FIG. 2 depicts a back isometric view of the portable garment treatment apparatus of FIG. 1;

FIG. 3 depicts the base of the portable garment treatment apparatus of FIG. 1;

FIG. 4 depicts the base of FIG. 3 including a blower;

FIG. 5 depicts the frame system of the portable garment treatment apparatus of FIG. 1;

FIG. 6 depicts the shelving system of the portable garment treatment apparatus of FIG. 1;

FIG. 7 depicts the shelving support structure of the portable garment treatment apparatus of FIG. 1;

FIG. 8 depicts the removable top frame member of the portable garment treatment apparatus of FIG. 1;

FIG. 9 depicts a side view of the portable garment treatment apparatus of FIG. 1 in a fully expanded configuration;

FIG. 10 depicts a side view of the portable garment treatment apparatus of FIG. 1 in a partially expanded configuration; and

FIG. 11 depicts the portable garment treatment apparatus of FIG. 1 in a collapsed configuration

### DETAILED DESCRIPTION OF THE INVENTION

The present disclosure relates to a portable garment treatment apparatus. The garment treatment apparatus includes a collapsible enclosure supported by an expandable frame. The expandable frame can adjusted to increase or decrease the size of the enclosure, or in the alternative, can be collapsed to minimize the size of the apparatus for storage. A blower unit is attached to the apparatus to provided air into the enclosure.

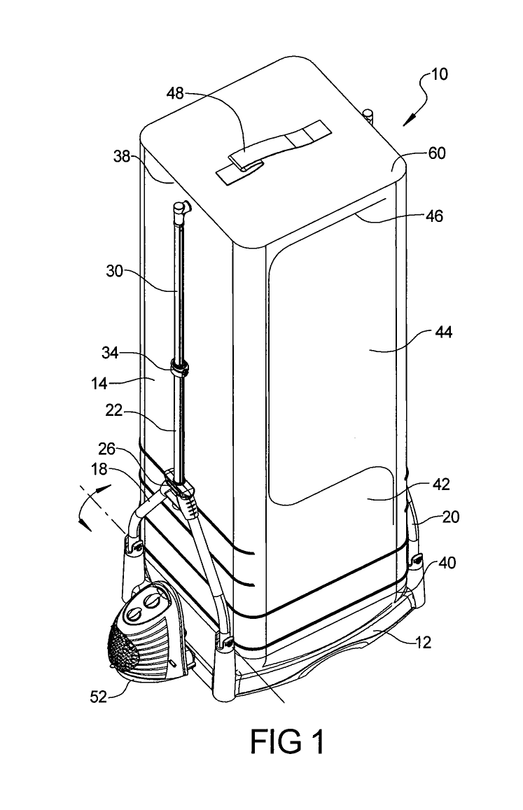

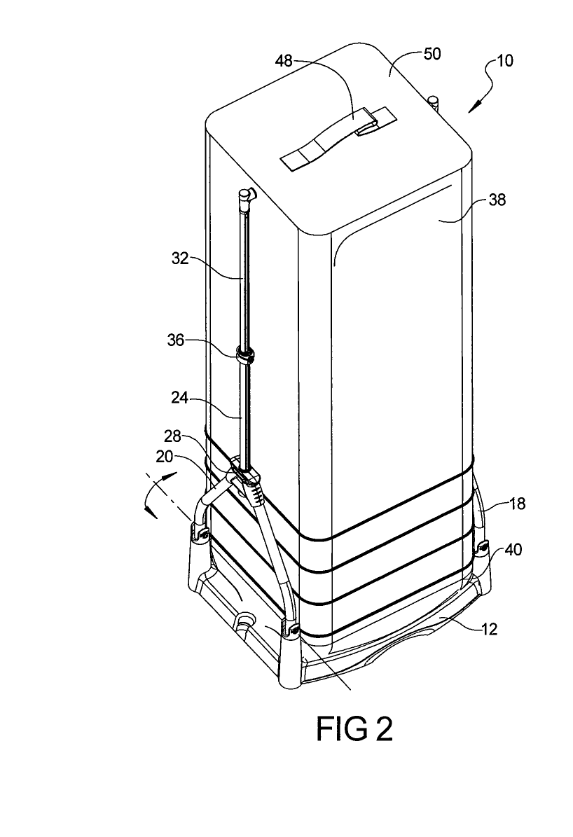

Referring now to the drawing figures in which like reference designators refer to like elements, there is shown in FIGS. 1 and 2 a garment treatment apparatus 10 of the present disclosure. The garment treatment apparatus includes a base 12 having a pair of opposingly mounted telescoping frame assemblies 14 and 16. Each frame member 14 and 16 includes a lower frame member 18, 20 pivotally mounted to the base 12. The lower frame members 18, 20 are pivotable with respect to the base 12 between a substantially vertical position, for when the apparatus 10 is in use, and a substantially horizontal position, for storage of the apparatus 10. In the horizontal position the lower frame members 18, 20 are rotated onto the base 12, minimizing the vertical height of the apparatus 10.

The frame members 14 and 16 each include a first mast 22, 24 sliding mounted to the lower frame 18, 20. The first masts 22, 24 are telescoping with respect to the lower frames 18, from a compact first position to an extended second position. A locking mechanism 26, 28 is provided on each of the lower frames 18, 20 for locking the position of the first masts 22, 24 with respect to the lower frames 18, 20.

A second mast 30, 32 is telescopically mounted to each of the first masts 22, 24. The second masts 30, 32 are slideable with respect to the first masts 22, 24 from a retracted first position to an extended second position. A locking mechanism 34, 36 is provided on each of the first masts 22, 24 for locking the position of the second masts 30, 32 with respect to the first masts 22, 24.

The first and second masts 22, 24 and 30, 32 are selective positionable from a retracted position to an extended position. In the retracted position, the first and second masts 22, 24 and 30, 32 are fully retracted within the lower frames 18, 20, such that the lower frames 18, 20 can be rotated to the horizontal position with respect to the base 12. In the extended position, the lower frames 18, 20 are rotated to a vertical position, and the first and second masts 22, 24 and 30, 32 are either partially or fully extended in the vertical direction.

The locking mechanisms 26, 28 and 34, 36 can be snap-lock or detent and ball type locking mechanisms. However, it is contemplated that other known types of locking mechanisms can be utilized to lock the travel of a masts 22, 24 and 30, 32.

A collapsible enclosure 38 is mounted to and supported between that the frame assemblies 14 and 16. The collapsible enclosure 38 can be expanded from a compact position to an expanded position. In the compact position, the enclosure 38 is folded into the base 12, the frame assemblies 14 and 16 being rotated over the enclosure 38. In the expanded position, the enclosure 38 is vertically raised as the first and second masts 22, 24 and 30, 32 are either partially or fully extended in the vertical direction.

A lower end 40 of the enclosure 38 is removable attached about the base 12, such that as the enclosure 38 is expanded, defining an interior space, The interior space is configured for receiving the garments to be treated. A front surface 42 of the enclosure 38 includes an access panel 44 for providing access to the interior space of the enclosure 38. The front surface 42 further includes a closure mechanism 46 for the opening and closing of the access panel 44 to the front surface 42. The closure mechanism can be a zipper, hook and loop, or other types of know closure mechanisms. Only one access panel is depicted in the figures, however, it is contemplated that the enclosure can include one or more access panels.

A handle 48 can be provided on a top surface 50 of the enclosure 38. The handle 48 can be utilized to facilitate the raising and lowering of the enclosure 38.

A blower unit 52 is removable connected to the base 12. The blower unit 52 is connected to the base 12 to provide a continual stream of air to the interior space of the enclosure 38. The blower unit 52 can include a heating element to provide heated air to the interior space of the enclosure 38.

The blower unit 52 can further function as a heater, humidifier, ozonator, ionizer, oderizer, dryer or steamer. The blower unit 52 can also perform a combination of the above noted functions.

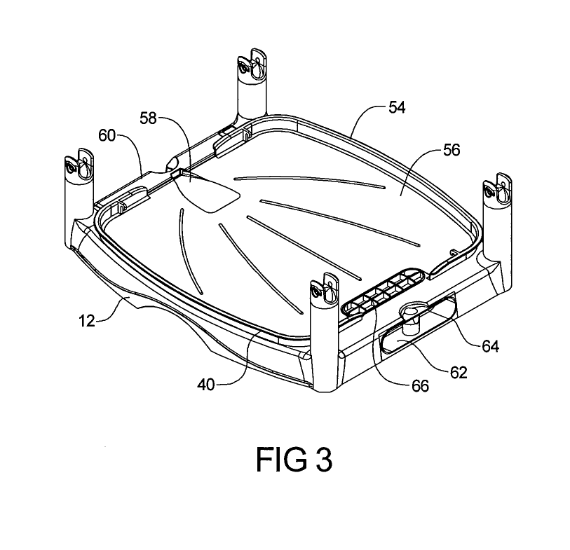

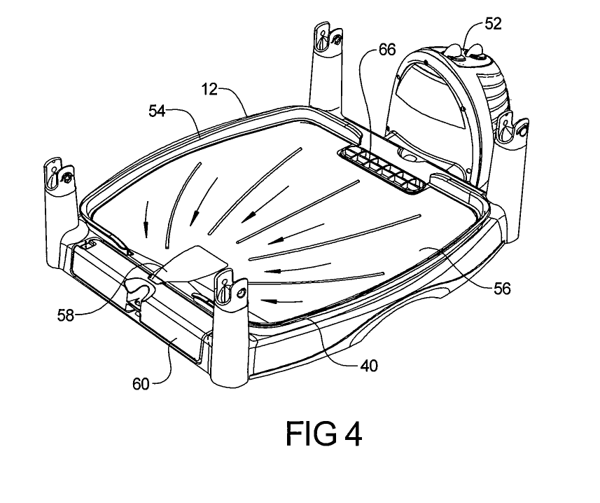

Referring to FIG. 3, the base 12 includes an indented tray 54 configured to collect moisture from garments positioned in the enclosure 38. The bottom surface 56 of the tray 54 is provided at an incline to facilitate movement of the collected fluid toward and exit port 58 for collection in a removable collection tray 60.

The base 12 further includes an air duct 62, having a first open end 64 for attachment of the blower 52. The air duct 62 extends through the bottom surface 56 of the tray 54 having a second open end 66 through which the blower 52 vents air into the enclosure 38.

The edge 64 of the indented tray 54 can includes a lipped portion 66 for attachment of the lower end 40 of the enclosure 38. However, is in also contemplated that other attachment mechanisms can be used, including, but not limited to, zippers, hook and loop-, snapper, and other know devices.

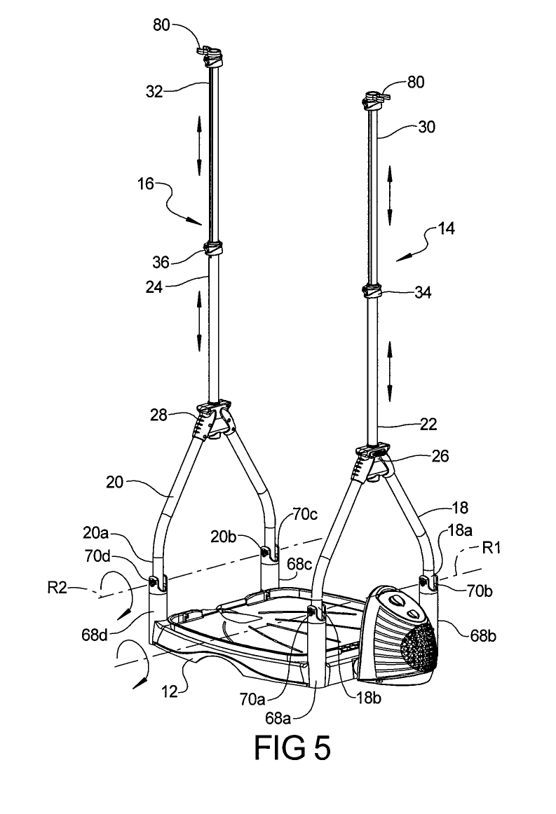

Referring also to FIG. 5, that base includes extensions 68a-d, each have a pivotally connection 70a-d. The pivotal connections 70a and 70b are aligned defining an axis of rotation R1. The ends 18a-b of the lower frame 18 are one each connected to the pivotal connections 70a-b, such that lower frame 18 is rotatable about axis of rotation R1.

Similarly, pivotal connection 70c and 70d are aligned defining an axis of rotation R2. The ends 20a-b of the lower frame 20 are one each connected to the pivotal connections 70c-d, such that lower frame 20 is rotatable about axis of rotation R2.

The extensions 68a-d can be hollow, such that the ends 18a-b and 20a-b of the lower frames 18 and 20 can be slide into the extensions 68a-d. In this manner the lower frames 18,20 can be locked in the vertical position. To rotate that lower frame 18,20 to the horizontal position, the ends 18a-b and 20a-b of the lower frames 18 and 20 lifted out of the extensions 68a-d and the lower frames 18,20 are rotated to the vertical position.

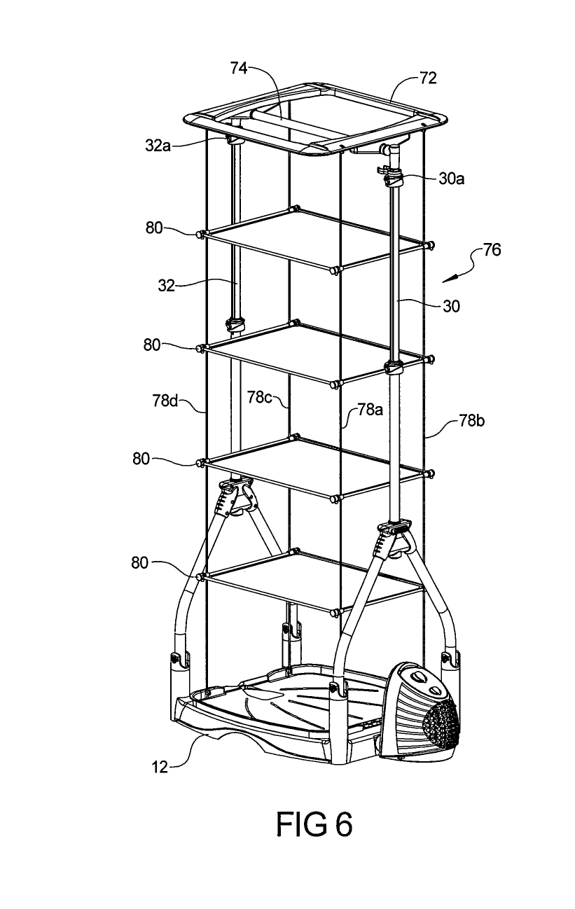

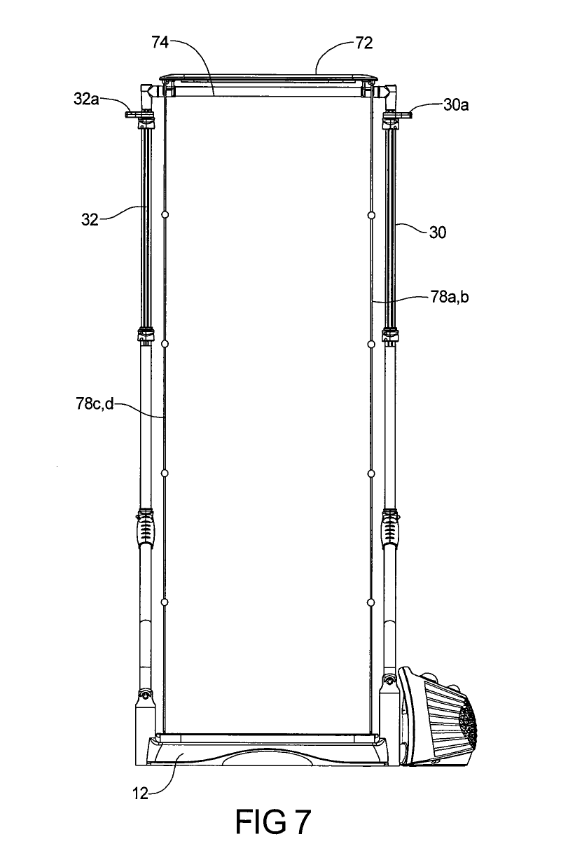

Referring to FIGS. 6 and 7, a top frame 72 is affixed the top ends 30a, 32a of the second masts 30, 32. The top frame 72 is shaped to conform to and support the top of the enclosure 38, where the enclosure 38 is fitted over the top frame 72. The top frame 72 can include a hanging bar 74, which can be utilized to support hanging garments.

A shelf system 76 is supported between the top frame 72 and the base 12. The shelf system 76 includes support members 78a-d extending between the top frame 72 and the base 12. One or more shelves 80 can be position on the support members 78a-d, where the shelves 80 provide a platform for the holding the garments. The shelves 80 can be removable attached to the support members 78a-d, such that the shelves 80 can be removed or repositioned as needed.

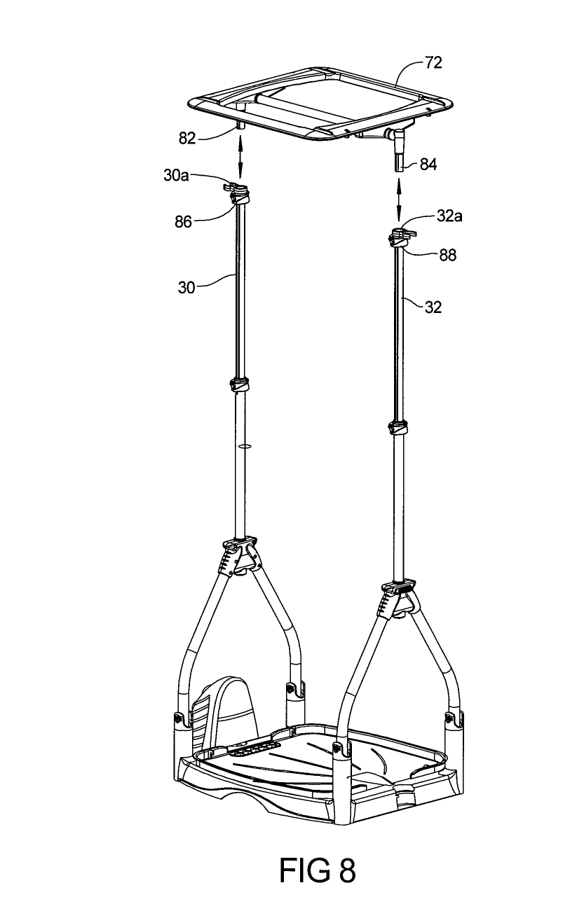

Referring to FIG. 8, the top frame 72 is removable connected to the top ends 30a, 32a of the second mast members 30, 32. The top frame 72 includes first and second extensions 82,84 extending downwardly. To connect the top frame 72 to the second masts 30, 32, the first and second extensions 82, 84 are aligned with and inserted into the top ends 30a, 32a of the second masts 30, 32. Locking mechanisms 86, 88 are provided at each of the top ends 30a, 32a, which engage and secure the first and second extensions 82, 84 into the top ends 30a, 32a. To remove the top frame 72, the locking mechanisms 86, 88 are actuated and the top frame 72 is removed. The locking mechanisms 86, 88 can be snap-lock or detent and ball type locking mechanisms. However, it is contemplated that other known types of locking mechanisms can be utilized to lock the top frame 72 to the second masts 30, 32.

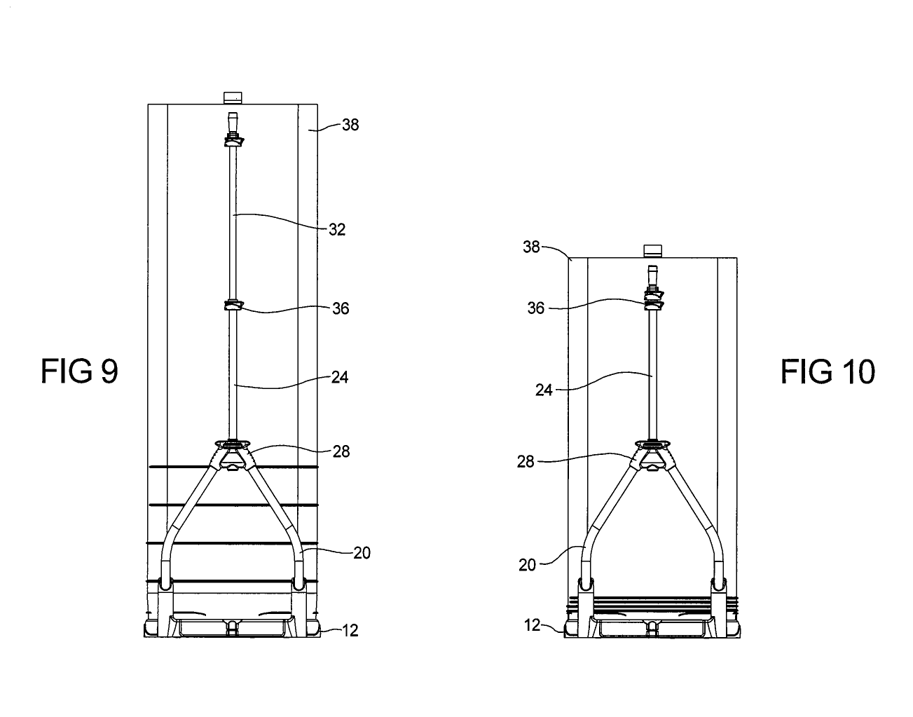

As previously noted, the size of the garment apparatus 10 of the present disclosure can be selectively increased or decreased. Referring to FIG. 9, in a fully expanded condition, the first and second masts 22, 24 and 30, 32 are fully extended, where the masts 22, 24 and 30, 32 and locking into position by locking mechanisms 26,28 and 34,36. Alternatively, as shown in FIG. 10, in a partially expanded condition, the first masts 22,24 are fully extended, where the first masts 22,24 are locked in position by locking mechanisms 26,28. The second masts 30,32 are un-extended, remaining nested within the first mast 22,24. In is also contemplated that first second masts can be separately, partially, extended, allowing for variation in the size of the garment apparatus 10.

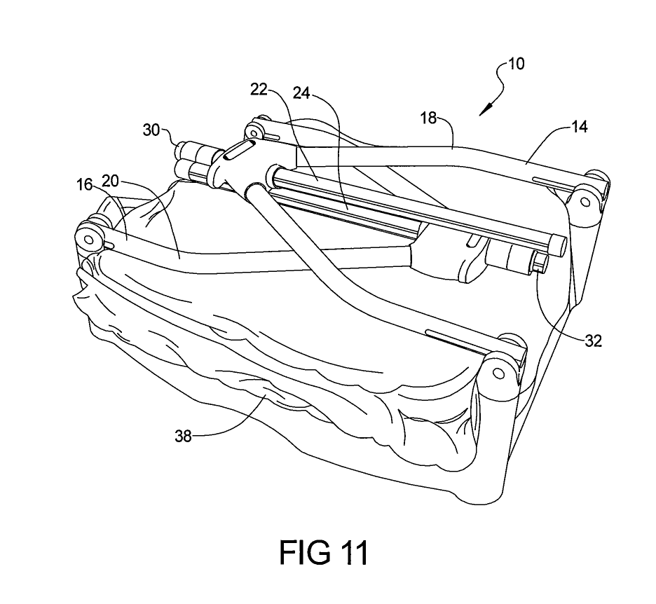

Referring also to FIG. 11, to collapse the apparatus, the first and second masts 22, 24 and 30, 32 are fully retracted. The second masts 30, 32 are retracted into the first masts 22, 24 and the first masts 22, 24 are retracted into the lower frames 18, 20. The top frame 72 is detached from the end 30a, 32a of the second masts 30, 32, such that the top frame 72 and enclosure 38 can be compressed onto the base 12. The lower frames 18 and 20 are separately rotated toward the base, such the frames 14 and 16 overlay each other on top of the collapsed enclosure 38. The frame assemblies 14, 16 can be held in place with locking member 80. In the collapsed configuration, the apparatus 10 can be stored.

In use, the framed 14 and 16 are separated and rotated into a substantially vertically position. The top frame 72 is connected to the ends 30a, 32a of the second masts 30, 32. The first and second masts 22, 24, and 30, 32 are selected raised and locked into place. For a fully size configuration, the first and second masts 22, 24, and 30, 32 are fully extended. The access panel 44 is opened and the garments are positioned in the interior space. The garments can be positioned on the shelves 80, or one or more of the upper the shelves 80 can be removed so that the garments can be hung from the hanging bar 74. Upon sealing the access panel 44, the blower unit 52 is turned on. Optionally, the heating element of the blower unit 52 can be actuated to provide heated air to the interior of the enclosure 80. The blower unit 52 can include differing air and temperature setting for the treatment of different types of fabrics.

Upon completion of use, the garments are removed from the interior space. The collection tray 60 is removed and any accumulated moisture therein is disposed of. The apparatus 10 is then collapsed for storage.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A collapsible garment treatment apparatus comprising:
a base;
a blower unit connected to the base;
a telescoping frame rotatably connected to the base, wherein the telescoping frame is rotatable from a substantially horizontal to a substantially vertical position with respect to the base; and
a collapsible enclosure connected to the base and the telescoping frame, wherein the collapsible enclosure can be expanded to define an interior space.

2. A collapsible garment treatment apparatus as set forth in claim 1, wherein the telescoping frame includes:
a lower frame member pivotally connected to the base;
a first mast sliding connected to the lower frame member; and
a second mast telescopingly connected to the first mast.

3. A collapsible garment treatment apparatus as set forth in claim 2, wherein the first and second masts can be selectively extended and retracted.

4. A collapsible garment treatment apparatus as set forth in claim 1, wherein the telescoping frame includes:
a first frame assembly pivotally connected to a first side of the base; and
a second frame assembly pivotally connected to a second side of the base, opposite the first side of the base.

5. A collapsible garment treatment apparatus as set forth in claim 4, wherein the first and second frame assemblies each include:
a lower frame member pivotally connected to the base;
a first mast sliding connected to the lower frame member; and
a second mast telescopingly connected to the first mast.

6. A collapsible garment treatment apparatus as set forth in claim 5, wherein the first and second masts can be selectively extended and retracted.

7. A collapsible garment treatment apparatus as set forth in claim 4, wherein the collapsible enclosure is positioned between and supported by the first and second frame assemblies.

8. A collapsible garment treatment apparatus as set forth in claim 7, further comprising removable shelves positionable in the interior space of the collapsible enclosure.

9. A collapsible garment treatment apparatus as set forth in claim 1, the base including an indented tray having an inclined bottom surface.

10. A collapsible garment treatment apparatus as set forth in claim 9, the base including a moisture collection tray in fluid communication with the inclined bottom surface.

11. A collapsible garment treatment apparatus as set forth in claim 9, the base including an air duct having a first open end configured for receiving the blower unit and a second open end positioned in the inclined bottom surface.

12. A collapsible garment treatment apparatus as set forth in claim 1, wherein the collapsible enclosure includes a resealable access panel.

13. A collapsible garment treatment apparatus comprising:
a base;
a blower unit connected to the base;
a telescoping frame including a first frame assembly pivotally connected to a first side of the base and a second frame assembly pivotally connected to a second side of the base, opposite the first side of the base, wherein the first and second frame assemblies are rotatable from a substantially horizontal to a substantially vertical position with respect to the base; and
a collapsible enclosure positioned between and supported by the first and second frame assemblies and having a bottom end secured to the base, wherein the collapsible enclosure can be expanded to define an interior space.

14. A collapsible garment treatment apparatus as set forth in claim 13, wherein the first and second frame assemblies each include:
a lower frame member pivotally connected to the base;
a first mast sliding connected to the lower frame member; and
a second mast telescopingly connected to the first mast.

15. A collapsible garment treatment apparatus as set forth in claim 14, wherein the first and second masts can be selectively extended and retracted.

16. A collapsible garment treatment apparatus as set forth in claim 13, further comprising removable shelves positionable in the interior space of the collapsible enclosure.

17. A collapsible garment treatment apparatus as set forth in claim 13, the base including:
an indented tray having an inclined bottom surface; and
removable moisture collection tray in fluid communication with the inclined bottom surface.

18. A collapsible garment treatment apparatus as set forth in claim 17, the base including an air duct having a first open end configured for receiving the blower unit and second open end position in the inclined bottom surface.
